(19) United States
(12) Patent Application Publication
(10) Pub. No.: US 2022/0156364 A1
(43) Pub. Date: May 19, 2022

(54) Method for Executing Secure Code, Corresponding Devices, System and Programs

(71) Applicant: BANKS AND ACQUIRERS INTERNATIONAL HOLDING, PARIS (FR)

(72) Inventors: Rémi Geraud, VALENCE (FR); Mamoudou Sylla, PARIS (FR)

(21) Appl. No.: 17/598,608

(22) PCT Filed: Mar. 24, 2020
(86) PCT No.: PCT/EP2020/058229

§ 371 Date: Sep. 27, 2021

(30) Foreign Application Priority Data
Mar. 28, 2019 (FR) FR1903300

(51) Int. Cl. G06F 21/54; G06F 21/55; G06F 21/14

(52) U.S. Cl. CPC G06F 21/54; G06F 21/14; G06F 21/554

(57) ABSTRACT

A method for controlling the running of an application. The method is implemented within the application, the application running on an electronic running device. The running device is connected to a calling device via a communication network. The method includes: receiving from the calling device a runtime data structure, including at least one recording, each recording having at least one data field including a coded function name; saving the runtime data structure in a specific memory zone; for each current recording of the runtime data structure, implementing a function bearing a decoded function name corresponding to the coded function name, when the function bearing a decoded function name of the application can be associated with the coded function name.

### CROSS-REFERENCE TO RELATED APPLICATIONS

This Application is a Section 371 National Stage Application of International Application No. PCT/EP2020/058229, filed Mar. 24, 2020, the content of which is incorporated herein by reference in its entirety, and published as WO 2020/193583 on Oct. 1, 2020, not in English.

### 1. FIELD

The invention relates to the securing of devices of users. The invention relates more particularly to the securing of communication terminals in the context of processing carried out remotely. In particular, the invention relates to the securing of the execution of code by an electronic device, called execution device, when the execution of this code is controlled remotely by a caller electronic device. A caller device can in particular take the form of a processing server or a securing server or a transaction server. More particularly, the invention has a use in the context of an implementation between a terminal (execution device) and a server (caller device), which desires to verify the integrity of the execution device and/or the integrity of a code that must be executed by the execution device. The invention can however be implemented in other types of systems comprising an execution device and a caller device.

### 2. Prior Art

While distributed system are becoming omnipresent, security mechanisms must be prepared to face the growing threats against these systems. The existing security mechanisms for distributed systems are based on the authentication of the clients and of the servers and on the protection of the data being processed or communicated using known encryption mechanisms on secure channels. These security mechanisms do not allow to authenticate the executions of programs on the clients or the servers, since the clients, the servers and the programs being executed can be compromised once the clients and the servers have passed an authentication phase.

Thus, for example, a communication terminal of a user has available an application that it downloaded from an application-providing service (“store”). Once downloaded and installed on the communication terminal, the application enters into communication with a server, for the implementation of one or more services. The conventional view of such an implementation is based on the hypothesis that the server implements all of the services requested by the application of the communication terminal. Thus, the majority of the securing work relates to the server, which is the object of all the precautions. However, more and more, the communication terminals of the users carry out sensitive operations, with respect to both the user who owns the communication terminal and the server(s) with which it exchanges data, which can turn out to be extremely sensitive (identity data, health data or data relating to health, payment data, etc.).

Existing techniques that implement a trusted root (static “static root trust” or dynamic “dynamic root trust” or hardware “hardware root trust”) based on the handling of trusted platform modules (TPM) form a first building block for the validation of the execution of code remotely on a host (execution device) potentially not secure: the communication terminals carry for the most part TEEs (trusted execution environments) and/or SEs (secure elements) that can execute sensitive operations. A trusted root is implemented by validating substantially the signature of an executable code just before its execution. As such, these mechanisms do not address the possible vulnerabilities at the moment of the execution in the complex software systems that call modules linked dynamically, locally or remotely, nor the dynamic substitution of regions of the executables by malicious components in the host kernel of the execution device (directly in the operating system).

The existing mechanisms for the validation of remote execution are intended for the detection of the violations of security on an execution device that executes programs for a caller device and/or on the instructions of the caller device. One approach often involves carrying out a validation of the code just before the execution (static validation). This approach is not sufficient, since a compromised module for managing memory or a file system can provide the original code to the verification function during the execution of the compromised code. The static validation of the executions is also limited in its inability to resolve the problems related to the injection of code at the moment of the execution, which is typical of certain viruses.

A need has appeared for a mechanism that validates a process at the moment of the execution. A need has also appeared for a mechanism that allows the caller device to launch the execution of code on the execution device dynamically, that is to say in a manner involving changing the execution flow. The specific problem addressed is the dynamic (that is to say at the moment of the execution) authentication of the code being executed on an execution device, potentially not approved, upon request from a caller device. Such a scenario is typical in the current internet world, in which the applications are executed on terminals of users, to respond to a request of a client. The existing solutions that address this problem or similar problems suppose the availability of trusted components on the potentially unapproved server and the most practical and acceptable available solutions use the trusted platform module (TPM). However, these solutions do not allow to modify the execution flow of a code (in particular remote), securely, without needing to update the executor software on the execution device. More particularly, in the context described above, no solution allows to carry out, securely, the execution of programs on a device, even when using secure platforms. The conventional approaches to executing code remotely come substantially in two forms:
either executing native code on the execution device; this native code must be either downloaded from the caller device to the execution device, or be generated using a compiler (in this second case it is a source code that is downloaded from the caller device to the execution device);
or executing a script using an interpreter (in this case it is a scripted code that is downloaded from the caller device to the execution device).

However, each of these solutions has limits, in particular, executing native code is risky since it potentially allows attackers to execute arbitrary programs and to take control of the execution device (this type of problem is very well known for the compilers called “Just-In-Time”, including WebAssembly, etc.). Moreover, the interpreters are slow and require all the relevant functionalities to be implemented. Moreover, the scripts cannot be optimised (contrary to a compiled binary).

There is therefore a need for a solution for executing code remotely that allows to take into account the issues mentioned.

### 3. SUMMARY

The method proposed by the inventors does not pose these problems of the prior art. Indeed, a method for controlling execution of a code of an application is proposed, a method implemented via an electronic device, called execution device ResB, B, in which said application is executable.

More particularly, a method is described for controlling the execution of an application AppO, a method implemented in the application AppO, said application AppO being executed on an electronic device, called execution device, said execution device being connected to a caller device via a communication network. The method comprises the following steps:
Receiving from the caller device an execution data structure, comprising at least one record, each record comprising at least one data field comprising an encoded function name;
Saving, in a specific memory zone, said execution data structure;
For each current record of the execution data structure implementing a function having a decoded function name corresponding to the encoded function name, when the function, of the application AppO, having a decoded function name can be associated with the encoded function name.

Thus, it is possible to implement a secure execution of one or more functions, while ensuring that a malicious device cannot carry out a search or an inference of the execution. The result(s) of execution of the function having a decoded function name can be transmitted to the caller device so as to control an execution flow by said caller device, of the masked function names. Therefore, an attacker cannot, easily, interfere with or understand the nature of the functions and of the results that are implemented in the context of the control of execution of the functions implemented by the caller device.

According to a particular feature, the step of implementation of the function having a decoded function name corresponding to the encoded function name comprises the following steps:
Obtaining the decoded function name from an encoded function name of said current record;
When the obtaining of the decoded function name from the encoded function name is positive, executing the function having the decoded name.

Thus, it is possible to voluntarily introduce errors into the execution data structure in order to throw off the attention of an attacking or malicious device.

According to a particular feature, the step of executing the function having a decoded function name, called current function, comprises the following steps:
Optionally, obtaining in the current record one or more execution parameters of the current function FCour;
Attempting to execute the current function Fcour with the optional execution parameter(s) previously obtained, with an exception mechanism upon execution;
When no exception upon execution is triggered, obtaining the result of execution of the current function;
Writing the result of the current function in a specific memory zone of the current record and/or of the following record of the execution data structure.

Thus, it is possible to serialise the execution of several functions by managing the possible failure of execution of these functions in a simple and efficient manner.

According to a specific embodiment, the method further comprises a step of obtaining in the current record at least one precondition for execution of said current function and the step of attempting to execute the current function FCour is only triggered if said at least one precondition is satisfied.

Thus, the execution of the functions is not limited to a simple linear series and can thus take into account the specificities of the execution device, of its operating system or of its virtual machine.

According to a specific embodiment, the step of implementing the function having the decoded function name corresponding to the encoded function name comprises a step of introspection of said application, delivering a positive introspection result when a function having the decoded function name is identified among the set of functions of said application.

Thus, the confidentiality of the function names is ensured.

According to a particular feature, the step of obtaining the decoded function name from the encoded function name of said current record comprises a step of searching for the presence of an existing function on the basis of an annotation comprising the encoded function name, said annotation being associated with the function having the decoded function name.

Thus, the application development is simplified.

According to a specific embodiment, said step of receiving the execution data structure is preceded by the establishment of a secure communication link.

According to a particular feature, said execution data structure is encrypted and the method comprises a step of decrypting the execution data structure.

According to another aspect, the invention also relates to a device configured to carry out a control of execution of an application AppO, said control being implemented in the application AppO, said application AppO being executed on a processor of said electronic device, called execution device, said execution device being connected to a caller device via a communication network.

Such an execution device comprises the following means:
Receiving from the caller device an execution data structure, comprising at least one record, each record comprising at least one data field comprising an encoded function name;
Saving, in a specific memory zone, said execution data structure;
For each current record of the execution data structure implementing a function having a decoded function name corresponding to the encoded function name, when the function, of the application AppO, having a decoded function name can be associated with the encoded function name.

The invention also relates, according to a complementary aspect, to a system for executing a code. Such a system comprises at least one caller device taking the form of an electronic control device (called caller device) as described above and at least one electronic execution device as described above accessible from the caller device.

Moreover, it is understood that in the context of the present a step of reception from a device corresponds to a step of emission from this device and vice versa so that the methods described above can be symmetrically implemented by a person skilled in the art.

According to a preferred implementation, the various steps of the methods according to the invention are implemented by one or more pieces of software or computer programs, comprising software instructions intended to be executed by a data processor of an execution device according to the invention and being designed to control the execution of the various steps of the methods, implemented in the communication terminal, the electronic execution device and/or the control device, in the context of a distribution of the processing to be carried out and determined by a scripted source code.

Consequently, the invention is also aimed at programs, capable of being executed by a computer or by a data processor, these programs including instructions for controlling the execution of the steps of the methods as mentioned above.

A program can use any programming language, and be in the form of source code, object code, or intermediate code between source code and object code, such as in a partially compiled form, or in any other desirable form.

The invention is also aimed at an information support readable by a data processor, and including instructions of a program as mentioned above.

The information support can be any entity or device capable of storing the program. For example, the support can include a storage medium, such as a ROM, for example a CD-ROM or a ROM of a microelectronic circuit, or a magnetic recording medium, for example a mobile support (memory card) or a hard disk or an SSD.

Moreover, the information support can be a transmittable support such as an electric or optical signal, which can be delivered via an electric or optical cable, by radio or by other means. The program according to the invention can be in particular downloaded over a network of the Internet type.

Alternatively, the information support can be an integrated circuit into which the program is incorporated, the circuit being adapted to execute or to be used in the execution of the method in question.

According to one embodiment, the invention is implemented via software and/or hardware components. In this respect, the term “module” can correspond in this document to either a software component or a hardware component or to a set of hardware and software components.

A software component corresponds to one or more computer programs, one or more subprograms of a program, or more generally to any element of a program or of a piece of software capable of implementing a function or a set of functions, according to that which is described below for the module in question. Such a software component is executed by a data processor of a physical unit (terminal, server, gateway, set-top-box, router, etc.) and is capable of accessing the hardware resources of this physical unit (memories, recording supports, communication buses, input/output electronic cards, user interfaces, etc.).

Likewise, a hardware component corresponds to any element of a hardware assembly capable of implementing a function or a set of functions, according to that which is described below for the module in question. This can be a programmable hardware component or with an integrated processor for the execution of software, for example an integrated circuit, a chip card, a memory card, an electronic card for the execution of a firmware, etc.

Each component of the system described above of course implements its own software modules.

The various embodiments mentioned above can be combined with each other for the implementation of the invention.

### 4. DRAWINGS

Other features and advantages of the invention will be clearer upon reading the following description of a preferred embodiment, given as a simple illustrative and non-limiting example, and the appended drawings, among which:

FIG. 1 describes a system in which the invention can be implemented;

FIG. 2 describes the general principle of the method forming the object of the invention;

FIG. 3 describes a specific embodiment of the processing method;

FIG. 4 presents the structure of the original application;

FIG. 5 illustrates an architecture of a caller device capable of implementing a processing method of the invention.

### 5. DESCRIPTION OF THE EMBODIMENTS

### 5.1. Reminders of the Principle

As disclosed above, the general principle of the invention involves transmitting, to an execution device B, a set of instructions (EInstr) and/or commands, remotely, from a caller device A. Hereinafter and above, an electronic execution device, an execution device, a terminal, a client are considered to refer to the execution device B. Likewise, a caller device, an electronic caller device, a server, a control device are considered to refer to the caller device A. The caller device A and the execution device B can be remote and connected via a communication network. The caller device A and the execution device B can be integrated into the same electronic device.

In a specific embodiment, described below, the caller device A is a server, which desires to ensure the compliance (with certain requirements in particular in terms of integrity and security) of an execution device B, which is a communication terminal.

Thus there is a situation in which an electronic caller device desires to have a called electronic device execute one or more functions, in particular to verify that the execution device B satisfies certain criteria in terms of security. One goal of the invention is to make it so that the execution of these functions remotely is guaranteed, both for the caller and for the called device, and that security measures allow to avoid a third-party electronic device, called fraudulent device, being able to request the execution from the execution device B while it is not authorised to do so. One goal is also to ensure that the execution device B satisfies certain requirements of the caller device (in particular in terms of updating). Finally, the goal is to allow a certain upgradeability of the requirements of the caller device while minimising the risks of reproducibility, both in the execution device B and in an intermediate “third-party” device.

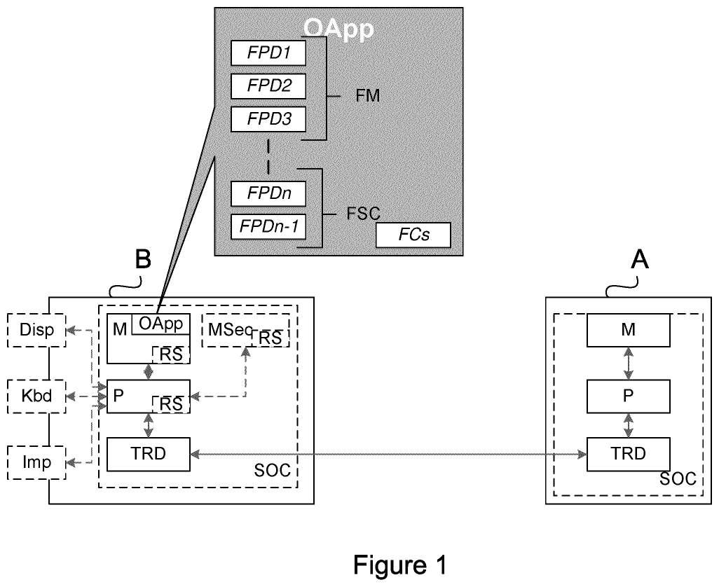

Before describing in detail the various mechanisms allowing to achieve these results, the technical architecture in which the invention is implemented is described, in relation to FIG. 1.

An electronic device A, called caller, comprises a processor P, a memory M, and data-transmission means TRD. These data-transmission means TRD can be in several forms, as is explained below. An electronic device B, called “called”, comprises a processor, a memory, and data-transmission means. These data-transmission means can be in several forms, as is explained below. The devices A and/or B can also comprise, according to the embodiments, (optional) software and/or hardware components for display Disp, input KBD and printing IMP.

The transmission means can for example be in the form of a data BUS, this data bus being connected, unidirectionally or bidirectionally, between the processor of the device A and the processor of the device B. Alternatively, two unidirectional transmission buses can be implemented: one allowing the transmission from the device A to the device B and one allowing the transmission from the device B to the device A.

In other situations, the data-transmission means can be in the form of a network communication interface. For example, the processor (of the device A and/or of the device B) is connected, via a data bus, to one or more components for emission/reception of data using one or more wired or wireless transmission technologies. In at least one situation the device A and/or the device B are in the form of an SOC (for System on Chip) which has available all of the components necessary for the implementation of the device.

In one embodiment, the device B is integrated into the device A, as an additional component thereof. In one embodiment, the device A is integrated into the device B, as an additional component thereof.

In an embodiment complementary to the other possible embodiments, the execution device B has available a secure processor and/or a secure memory Msec, allowing it to implement cryptographic functions. More particularly, the device B is capable of carrying out processing of encryption and of decryption of data, in particular received from the device A. The execution device B comprises for example, in its processor and/or its memory, specific registers RS for the processing of received data. In particular, the received data, after having been demodulated and/or decoded, according to the manner in which it was received, is placed in a set of specific registers (and/or memory zones). The data is placed in these registers (whether it is function-parameterisation data or function-name data, as is explained). The processor of the device B carries out processing for control and/or certification on the data placed in this specific set of registers (and/or of memory zones) before carrying out an action of using this data. The use of such specific registers allows to ensure that the data received (from the device A or from another device, for example fraudulent) is not compromised and can be used in the context of the implementation of one or more functions that must be implemented by the device B, normally for the device A.

It is supposed, in the context of the invention, that the execution device B has available an original application OApp, which was downloaded from an application store. The publisher of this application is a service provider that implements in particular the device A.

According to the invention, as presented above, the execution device B uses an application store to obtain the original application OApp. According to the embodiment and the operational implementation conditions, the original application OApp is either directly executed by the operating system of the communication terminal (this is therefore a native application), or executed via a virtual machine (VM).

The original application OApp is distributed openly in the application store. This original application OApp comprises in particular a set of predefined functions FPD1, . . . FPDn. In this predefined set of functions, two types of functions are distinguished: the first type comprises “overload” functions FSc, the goal of which is to overload functions of the operating system or functions of the virtual machine (VM) on which the application operates. These overload functions FSc are limited to calling a basic function and sending back the result of this basic function. These can be for example functions relative to obtaining the date, the time, the terminal model, the charge of the battery, the version number of such or such a software or hardware component, etc. These functions are overloaded for the needs of the original application. The second type comprises “application-specific” functions FM implemented specifically for the needs of the original application. These can be for example specific processing functions or calculation functions. These functions are defined by the publisher of the original application for their needs, with the goal of implementing a service or a portion of a service defined by them.

The original application also comprises specific communication functions FCs, allowing to exchange data, for example in serialised form, with the caller device A. These communication functions can comprise conventional protocol functions of the type opening of an http stream, establishment of a secure link, request transmission and response reception.

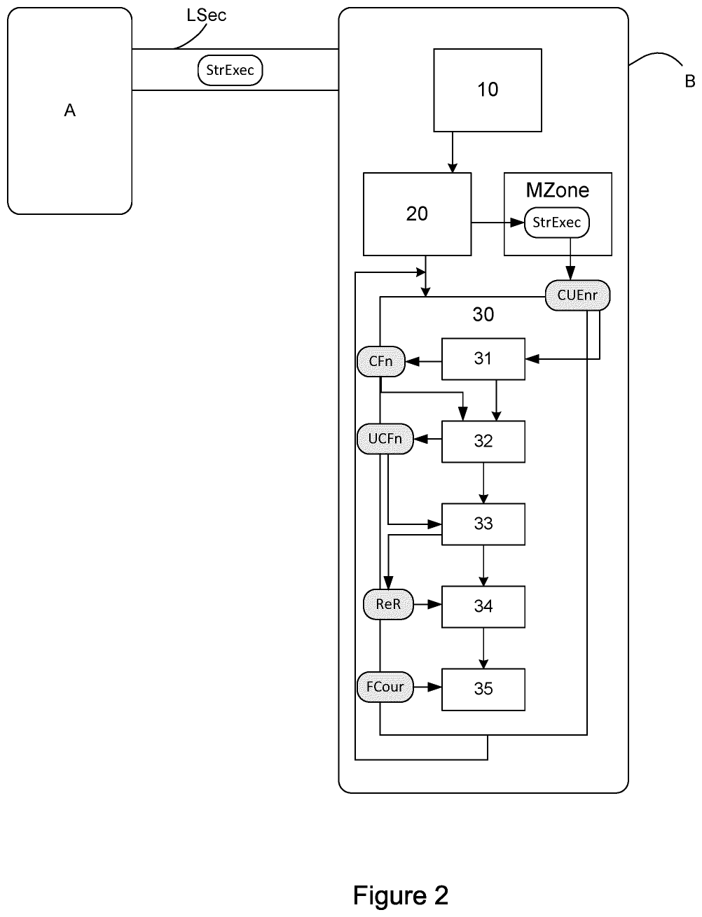

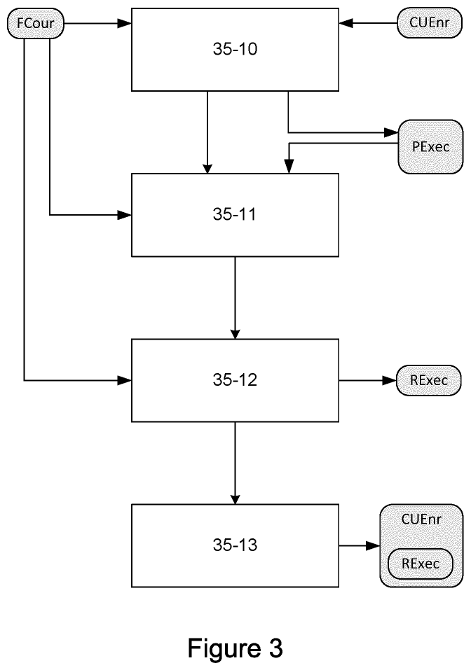

In order to solve the problems related to the security of the application, the security of the exchanges and the security of the execution device B, the implementation of a function call (which can be remote) from a caller device comprises the following steps, described in relation to FIGS. 2 and 3, which are implemented, after the establishment of a secure data-transmission link, called secure link:
Receiving 10 via the secure link LSec, from the caller device A, an execution data structure StrExec;

Saving 20, in a specific memory zone MZone, M, Msec, said execution data structure StrExec; For each current record CUEnr of the execution data structure StrExec, implementing 30 the following steps:
Obtaining 31 an encoded function name CFN;
Decoding 32 the encoded function name CFN, delivering a current function name, called decoded name UCFN;
Searching 33 for the presence of an existing function using the decoded function name UCFN, delivering a search result ReR;
When the search result is positive 34 (therefore indicating the presence of a function having the decoded name UCFN, thus called current function FCour), implementing 35 an execution step comprising:
   Optionally, obtaining 35-10 in the current record CUEnr one or more execution parameters PExec of the current function FCour;
   Attempting to execute 35-11 the current function FCour with the optional execution parameter(s) PExec previously obtained, with a mechanism for exception upon execution;
   When no exception upon execution is triggered, obtaining 35-12 the result RExec of execution of the current function FCour;
   Writing 35-13 the result RExec of the current function FCour in a specific memory zone of the current record CUEnr and/or of the following record of the execution data structure.

Steps 31 to 34, as explained below, can be implemented independently during the creation of a specific function, called execution function upstream of the function. The execution function is thus implemented in the execution step 35.

Thus, the method described allows to ensure that a malicious application, installed on the execution device B, cannot be informed of the processing implemented by the original application. The method described also allows an upgradeability of the original application, in particular by allowing the execution of functions, simple or complex, that are not originally provided. The method described also allows to ensure the caller device that the functions effectively executed by the application are indeed the functions that were expected by the caller device.

### 5.2. Execution Data Structure

Certain advantages are provided by the use of the execution data structure (also called secure execution structure) which is received by the original application and recorded in a memory zone available for the original application. The memory zone is preferably protected (either in a software manner, or in a hardware manner). However, even in the case of absence of protection, the benefits provided by the implementation of the method proposed are obtained. Indeed, the execution data structure comprises a set of records, each record of the set of records comprises an encoded function name CFN and a sequence of input parameters (IPSx) (this sequence of input parameters being optional) and one or more results fields (RESx). An encoded function name is for example in the form of a signature, encrypted or not, of the decoded function name. The decoded function name is not exposed in the execution data structure. An example of an secure execution structure is provided in [table 1].

TABLE 1

| | | |
|---|---|---|
| CFN_1 | IPS 1 | RES1 |
| CFN_2 | IPS 2 | RES2 |
| CFN_1 | IPS 3 | RES3 |
| CFN_4 | IPS 4 | RES4 |

Upon reading the above it is understood that the execution data structure is also a flow-control structure. In the example of table 1, the encoded function n#1 (CFN_1) is called, then the encoded function n#2 (CFN_2) is called, then the encoded function n#1 (CFN_1) is called once again, and to finish the encoded function n#4 (CFN_4) is called. The input parameters and optionally the results of the execution of the preceding function(s) are also used to execute the following function. Thus simultaneously the results of execution of the functions can be transmitted to the caller device, to control the execution flow and control the exactness of the intermediate results obtained by the called device, and the called device can use the results of execution of the functions to parameterise the execution of the following functions. The transmission of the results of execution of the flow can be direct (i.e. as soon as the function is executed) or can be carried out at the end of the execution of the execution flow, in the context of the transmission of a summary data structure to the caller device.

In operational conditions, the execution data structure is more complex than the example illustrated above. Indeed, the execution data structure can also comprise mechanisms for control of execution flow, allowing for example the conditional implementation of the functions according to the results of the previous executions, thus allowing a smart execution of the functions according to the specifications of the caller device. Thus, via this technique, it is possible for the execution device B to execute new application code (that is to say at least new in its chaining, or even completely new, according to the parameters provided), without needing to update the original application. [table 2] is another example of a secure execution structure.

TABLE 2

| | | | | |
|---|---|---|---|---|
| CFN_1 | PreEx_1 | IPS 1 | PostEx_1 | RES1 |
| CFN_2 | PreEx_2 | IPS 2 | PostEx_2 | RES2 |
| CFN_1 | PreEx_3 | IPS 3 | PostEx_3 | RES3 |
| CFN_4 | PreEx_4 | IPS 4 | PostEx_4 | RES4 |

Two columns are added in this table. More particularly, for each encoded function, one or more optional pre-execution conditions (PreEx_x) can be implemented. The same applies to the post-execution (PosrEx_x). Advantageously, and optionally, these execution conditions are encrypted (by the caller device) and they are decrypted on the fly (by the execution device), for example during the obtaining of the decoded function name (step 32) or during the obtaining of the execution parameters (step 35-10).

In another embodiment, the control of execution flow can be carried out in the caller device. More particularly, the secure execution structure only comprises a single record at a time. At each execution of the function contained in the secure execution structure, the result is immediately transmitted to the caller device, which makes decisions according to this result and transmits to the execution device B a new secure execution structure, comprising one or more records. The advantage here is to have available greater latitude in the control of the execution.

In at least one embodiment, instead of successively calling functions in order, for example according to the execution flow of table 2, a monadic composition is defined to create a specific function (called resulting function) that behaves like the composition of the functions to be called, according to the execution flow provided. This guarantees that the entire resulting function is executed (even if errors occur during the execution, the resulting function is capable of terminating) and makes this resulting function more efficient.

A Kleisli monad that uses errors of aggregates (several errors can thus be detected) is for example used to implement such a resulting function.

Thus, for example, the original application has available a composition controller. This controller uses the execution table (e.g. Table 1, Table 2) to construct a resulting function that comprises all of the functions of the execution table and optionally a series of associated conditional structures (e.g. table 2). The goal of this specific function, constructed in real time by the composition controller, is the implementation of the list of the functions of the table while allowing an efficient management of the possible errors that can occur during the execution of the functions of the execution table. Besides the monads, structures of the “try-catch” type can also be implemented according to embodiments and the language used.

Typically, an error can occur when the caller device orders the execution of a function (for example F1) to the execution device. This function, for which the caller device knows that it exists, in a version X theoretically takes three parameters at the input. The caller device receives the execution table and attempts to execute the function F1 with the three parameters provided. Unfortunately, the “version” Y of the function F1 in the possession of the execution device requires four parameters. Given that the original application does not have available this fourth parameter, the attempt to execute F1 causes an error. Without a mechanism for composition and/or interception, such a situation would lead to the stoppage of the resulting function, and thus to the impossibility to implement the other functions of the resulting function. Via the technique for management of the resulting function, the execution of all of the functions, according to the desired execution flow, is possible, even when all or a part of the set of functions of the execution table cause execution errors.

Moreover, these execution errors are made up for and are inserted into the structure of results transmitted by the original application.

Moreover, the controller (or the original function) provides, according to the embodiments, a serialised version of the functions that are executed, also in the structure of results in order for the contents of these functions to be able to be subject to an authentication.

### 5.3. Securing the Execution by Introspection

Among the important steps of the method described above, there is the decoding 32 of the encoded function name CFN, delivering a current function name, called decoded name UCFN, and the search 33 for the presence of an existing function using the decoded function name UCFN. According to the operational conditions of implementation these two steps can consist of the same single steps.

In a first embodiment, the encoded function name consists of a signature of a function name, known to the caller device. Indeed, according to the invention, the manager of the original application is at least partly linked to the service provided by the caller device. The caller device is thus capable of finding out the set of predefined functions FPD1, . . . FPDn in the original application beforehand. The caller device (or rather the manager of the caller device) can thus, on the basis of the set of predefined functions FPD1, . . . FPDn in the original application, derive a structure of the encoded function name CFN data. The transformation of a predefined function name FPD_x into an encoded function name CFN_x is carried out, in this embodiment, by the application of a signature algorithm (ASig). This can be a simple signature (obtained for example via a conventional hash function), or a particular signature that involves a cryptographic function and an encryption key, for example such as a session encryption key obtained during the establishing of the secure data-transmission link. Thus the transformation of a predefined function name FPD_x into an encoded function name CFN_x is carried out either beforehand, or in real time, the second solution having the best performance from a security point of view.

Regardless, when it receives the secure execution structure, the original application of the execution device B carries out, in this embodiment, a decryption, optional, that delivers an unencrypted signature. On the basis of this unencrypted signature, in this first embodiment, a decoding of the signature is carried out and an introspection (reflexivity) mechanism is used to allow the search for or the immediate call of the function on the basis of its decoded name, if the latter is correct. Additionally, a mechanism of annotation of the code is implemented in the original application. This allows to assign to each function a tag that will persist until the obfuscation (even if the obfuscation carries out a string encoding and other manipulations, the reflexivity guarantees that the program itself can always read its own strings). These two mechanisms (reflexivity and annotation) are used to facilitate the execution of functions, including new functions, never previously called, while avoiding the issue of parsing of a command that is transmitted unencrypted. Thus, it is possible to call a function at the moment of the execution by knowing its name (and by providing it with parameters). This approach poses, however, two problems that are solved by the technique previously described:
It is not desirable to authorise the calling of all the functions, since this would lead to an absence of security: this is solved by using a signature (optionally cryptographic) of the name of the function, which is verified before carrying out the call, as explained above.
During the use of the obfuscation, the function names are modified.

To provide a solution to the second problem, an annotation mechanism is used that allows to assign to each function a tag that persists until the obfuscation (even if the obfuscation carries out a string encoding and other manipulations, the reflexivity guarantees that the program itself can always read its own character strings upon execution). These two problems can be solved elegantly with the same solution, namely the signature itself. The use of the annotations provides another layer of protection, since the functions without annotations cannot be called (even if an attacker manages to guess the name of an obfuscated function and forge a cryptographic signature of this obfuscated function).

Thus, in summary, during the design of the original application, an annotation is added, similar to:

@remote (code=H)

This annotation is added to the function to which it is desired to be able to authorise calls via the mechanism described in the present application. The code H is (for example) the hash of the name of the function as decided by the designer of the original application, and corresponds to an encoded function name CFN.

In this embodiment, to call the function UCFN corresponding to the annotation CFN, the caller device transmits the code H (signed) (as an encoded function name in the secure execution data structure). The original application of the execution device B verifies the signature and, when the latter is valid, uses the reflexivity to search for a function UCFN with the corresponding annotation (that is to say with the annotation H corresponding to the CFN). Then, by using once again the reflexivity, the original application calls this function UCFN. Thus, this embodiment only requires little modification in the manner in which the original application is designed.

In another embodiment, a declaration mechanism that offers the possibility of associating a code H (an encoded function name CFN) with a decoded function name UCFN is implemented. Although this technique is suboptimal with respect to the use of annotations, it also allows to ensure a certain protection of the names of the functions: a table is present in the application. It comprises as many records as there are functions for which it is desired to authorise an execution via the method described above. Each record comprises two fields: a field comprising the encoded function name CFN and a record comprising a cipher (an encrypted version) of the decoded function name UCFN. This encrypted version of the decoded function name is called CCFN. In this embodiment, therefore, rather than using the reflexivity mechanism twice, it is only used once. [table 3] is an example of a declaration structure.

TABLE 3

| | |
|---|---|
| CFN1 | CCFN1 |
| CFN2 | CCFN2 |
| CFN3 | CCFN3 |
| CFN4 | CCFN4 |

In this embodiment, there are two versions of the function name: a version corresponding to the signature (optionally encrypted) CFN and an encrypted version CCFN. Upon execution, the application core of the original application receives the encoded (and encrypted) function name CFN_x, and as indicated above, verifies that the signature is valid. If the signature (corresponding to the encoded function name CFN_x) is valid, it searches in the declaration structure for the encrypted version of the function name CCFN_x corresponding to the encoded function name CFN_x. Once the encrypted version of the function name CCFN_x is obtained, the application core decrypts this encrypted version (in RAM, the result of the decryption is not copied to mass storage) and uses this result for the operation of introspection that delivers the real function name CFN that is thus called. The operation of decrypting the function name is advantageously carried out via a key, for example a specific private key, the encryption having been carried out at the moment of the compilation of the original application, using a public key generated by the compiler or the link publisher, for example. As for the private key, it is transmitted for example after the establishment of the secure data-transmission link with the caller device. Thus, the execution device B (and the original application) is not in possession of this private key and cannot therefore implement processing of the secure execution structure before having received this private key from the caller device.

### 5.4. Making Available the Functions of the Original Application

As explained above, the execution of a function via the secure execution structure is only possible if this function is authorised to be executed. Two specific embodiments were presented to do this:
an annotation mechanism, the object of which is in a way to link the function UCFN to an encoded function name CFN: with this embodiment, if a function UCFN is not annotated with its encoded function name CFN, it cannot be the object of a call via the secure execution structure. This allows to drastically limit the call possibilities by this path and thus increases the security of the application; and/or
a declaration record mechanism, based on the use of a specific table, associating encoded function name and encrypted function name according to two different methods, the advantage being that it is possible by this path to update this specific table, which can be received directly from the caller device, at the moment of the execution, which it is not possible to do with the annotations;
In addition to the “annotated” functions, there is a single entry point, a “meta” function, which takes as input an encoded function name CFN and arguments (for example in the form of a table) and uses the reflexivity (the introspection), as described above, to call such or such function or method.

All of the mechanisms described above can of course be combined to obtain a flexible original application that the caller device can have execute numerous functions, provided or not provided in advance, securely.

### 5.5. Ensuring the Execution by the Execution Device

Among the requirements that can arise during the implementation of the present technique, ensuring that the code executed is correct is surely one of the most important ones. Thus, in order to ensure that the program has executed as intended, the use of the monadic composition is implemented. Thus, in addition to the potential error messages intercepted during the execution and the result sent back, the monitoring of execution can be (signed and) sent back to the caller device. It is also possible to serialise the assembled program (resulting function) and send it for inspection to the caller device: such an implementation is not necessarily efficient, in particular from the point of view of the use of the network resources, but the use of the monadic composition to obtain the resulting function makes this solution possible.

### 5.6. Secure Link Between the Caller Device and the Execution Device

The establishment of the secure data-transmission link is implemented by the application core of the original application, independently, upon startup of the original application on the execution device. More particularly, upon startup of the original application, the following method is implemented:
the application core loads the application parameters into a (secure) memory zone, if they are not already loaded (or in cache);
the application core loads the (communication) module comprising the set of communication functions;
the application core searches in the (secure) memory zone for the connection parameters and values;
in collaboration with the caller device and the communication module, the application core establishes the secure data-transmission link, comprising for example: p2 defining the parameters for encrypting decrypting data in a session, for example http/http2 secured by the SSL and/or TLS protocol;
   defining a session key, derived from pairs of private keys/public keys in the possession of the application core and of the caller device.

The session can be directly set up between the original application and the caller device. It can also be set up with an intermediate device, present on the communication network, with which the original application determines the parameters for connection to the caller device, to then launch a session with the caller device.

Regardless of the mode used, after this startup, the original application has established, with the caller device, a secure communication session, allowing the caller device to transmit secure execution structures, as described above, to the original application.

In a complementary manner, the original application can establish a communication session with a complementary electronic device, for example an electronic verification device (verification device C) that is the recipient of the results of the executions of the functions implemented by the execution device. The establishment of this session follows the same steps as those previously described and the verification device C takes the place of the caller device A for the verification (and optionally the authentication) of the results of execution. In such a case, the caller device A acts as a device for transmitting commands while the verification device C carries out the operations of verification and/or certification and/or authentication of the results obtained.

### 5.7. Structuring of the Original Application

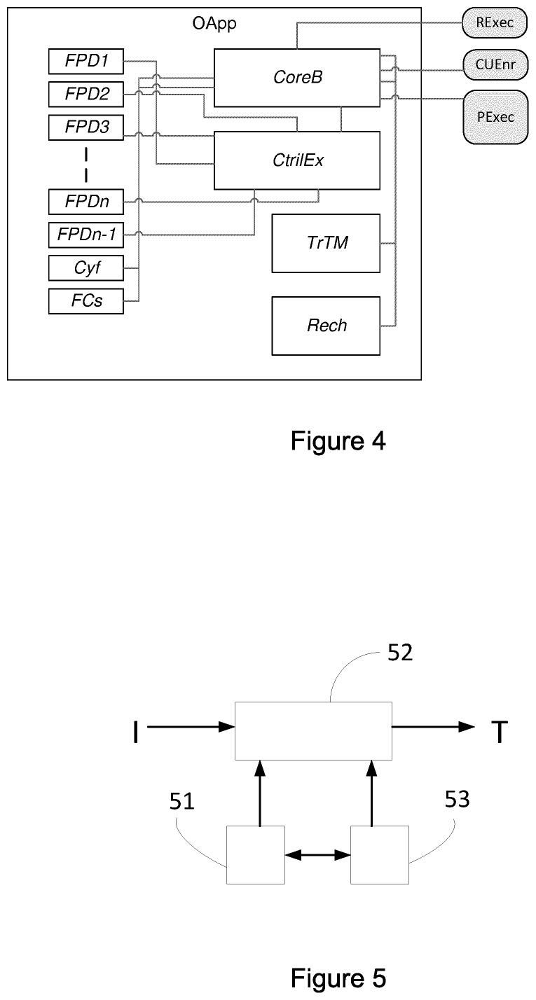

FIG. 4 presents the structure of the original application as implemented in the context of the invention. The original application comprises:
an application core CoreB, an important function of which is to process the data structures received from the caller device, as explained above;
a set of predefined functions FPD1, . . . FPDn; each predefined function of the set of predefined functions comprises a real function name;
an execution controller CtrilEx, in particular handling the control of execution flow when this functionality is implemented, and managing the implementation of the step 35 described above;
a set of communication functions FCs, allowing the transmission and the reception of data with the caller device, this set of communication functions being implemented independently by the application core of the application, in the context of the exchanges with the caller device and/or in the context of exchanges with other “authorised” services;
an encryption module Cyf, allowing to encrypt and to decrypt data;
a module TrTM for processing execution data structures, said execution data structures being, as explained above, received from the caller device; this module can be merged into the application core;
a module Rech for searching, in a data structure, for real function names according to codified function names (codified function names present in the execution data structure(s)), according to the method described above; this module can be merged into the application core.

It is noted that, according to the invention, the original application does not have an API. The original application does not expose a remote application interface that would comprise a (direct) access to the masked functions. The application is not capable of receiving a function call (which can be remote) from a caller device, other than via the mechanism described above. Thus, the application, via its communication functions, is capable of receiving an execution data structure, taking the form for example of a JSON, XML, CSV or other stream, this stream comprising a set of hidden function names and parameters, which are optionally encrypted using an encryption key coming from the creation of the secure communication link.

It is also noted that the implementation of the invention, for all its embodiments, can be carried out on an electronic device comprising both an electronic execution device and an electronic control device as described above. It is also noted that all the features of the embodiments can be combined in order to produce expected effects, and in particular to allow the execution of functions or of chainings of functions not necessarily provided in advance, without having to modify the original application.

### 5.8. Description of a Specific Embodiment

In an embodiment adapted to the processing of transactions implementing sensitive data (biometric data, voice signatures, digital fingerprints, health data, payment data), a communication terminal of a user is provided with an application, the object of at least some functions of which can be the manipulation of such data. For example, the application in question can be a payment application or a banking application. In the context of this embodiment, the manager of the service makes available in an application store an original application. In order to avoid important data being extracted from the original application, and with the goal of guaranteeing the security and the integrity of the data that is processed by the latter, the original application corresponds to the description made above.

In operational conditions, the caller device is for example a banking server or a transaction server handling payment data. During the execution of the application, the method described above is implemented. This method allows the banking server to command the original application installed on the communication terminal of the user, the commands in question are inserted into the execution structure that is transmitted, via the secure transmission link, to the original application of the communication terminal. The goal of this transmission can be to verify the correct operation of the original application and/or to obtain information on the communication terminal of the user and/or to execute application-specific code. Upon reception of this execution structure, the application implements the method described above to transmit the result(s) of execution of the functions to the banking server. The latter is thus capable of analysing the results obtained. The commands transmitted to the communication terminal and the analysis of the results obtained can have several purposes. In particular, this can be to verify that the communication terminal is in an acceptable state to be able to implement other functions. For example, the object of the commands (and thus of the functions executed) can be to determine what is the version of the operating system installed, what is the version of the virtual machine installed, what are the times and dates of the communication terminal, what are the versions of the encryption libraries and/or of the communication libraries or what are the states of the securing elements (SE, TEE). This first command series and the results that are provided thus allow the banking server to estimate a state of risk of the communication terminal, and allow for example to decide to continue or not the operations carried out with the communication terminal. According to the appearance of new vulnerabilities, the commands that are transmitted to the communication terminal by the banking server can vary over time. For example, if a vulnerability is discovered in a data-compression library, the banking server can thus integrate into the commands that it transmits to the communication terminal a command to verify the version of the compression library.

The commands can also, as explained above, embody a new function, not previously existing, that is the result of the chaining of the set of functions of the execution structure. The unit functions (UFCN) of the execution structure can thus comprise a set comprising application-specific functions and/or basic functions of the operating system and/or of the virtual machine in order to form a single function that did not previously exist. With such an implementation, it is understood that an attacker, even if they have available sensitive information on the communication terminal, will not be able to gain knowledge of the logical chaining implemented via the execution structure, and thus will not be able to understand the real operation of the application.

Moreover, another advantage of this manner of proceeding lies in the fact that the banking server can deliberately introduce into the execution structure useless function calls, the only goal of which is to disturb the analysis of the behaviour of the application. Thus, via this implementation, there is a very secure application, capable of resisting attacks more effectively.

Moreover, in a specific embodiment, the goal of the commands is to update the original application. The functions available in the original application can thus comprise functions of compilation and of publishing of links, which, when they are commanded by the caller device, take in the transmission data structure a source code or a partially compiled code, which is compiled by the original application for an update of its own application structure.

### 5.9. Other Features and Advantages

In relation to FIG. 5, a simplified architecture of an electronic execution device capable of carrying out the processing and the execution of code according to the method described above is presented. An electronic execution device comprises a memory 51 (and/or optionally secure and/or two separate memories, one secure and the other not), a processing unit 52 equipped for example with a microprocessor (and/or optionally secure and/or two separate processors, one secure and the other not), and controlled by the computer program 53, implementing the method as described above. In at least one embodiment, the invention is implemented at least partly in the form of an application AppO installed on this device. Such a device comprises:
means for receiving from the caller device an execution data structure, comprising at least one record, each record comprising at least one data field comprising an encoded function name;
means for saving, in a specific memory zone, said execution data structure;
means, used for each current record of the execution data structure, for the implementation of a function having a decoded function name corresponding to the encoded function name, when the function, of the application AppO, having a decoded function name can be associated with the encoded function name.

For the execution of the functions that it is tasked with, the device also comprises the means for implementing all of the steps mentioned above, either in hardware form, when specific components are dedicated to these tasks, or in software form in relation to one or more microprograms being executed on one or more processors of the execution device.

Although the present disclosure has been described with reference to one or more examples, workers skilled in the art will recognize that changes may be made in form and detail without departing from the scope of the disclosure and/or the appended claims.

1. A method for controlling execution of an application, the method being implemented in the application, said application being executed on an electronic device, called an execution device, said execution device being connected to a caller device via a communication network, said method comprising:
receiving from the caller device an execution data structure, comprising at least one record, each record comprising at least one data field comprising an encoded function name;
saving, in a specific memory zone, said execution data structure; and
for each current record of the execution data structure:
implementing a function having a decoded function name corresponding to the encoded function name, when the function, of the application, having a decoded function name can be associated with the encoded function name; and
transmitting, to said caller device, of a result of execution of the function having a decoded function name so as to control an execution flow by said caller device.

2. The method for controlling the execution of an application according to claim 1, the implementing the function having a decoded function name corresponding to the encoded function name comprises:
obtaining the decoded function name from the encoded function name of said current record;
when the obtaining of the decoded function name from the encoded function name is positive, executing the function having the decoded name.

3. The method for controlling the execution of an application according to claim 2, wherein the executing the function having a decoded function name, called current function, comprises:
obtaining in the current record one or more execution parameters of the current function;
attempting to execute the current function with the one or more execution parameters previously obtained, with an exception mechanism upon execution;
when no exception upon execution is triggered, obtaining the result of execution of the current function;
writing the result of the current function in the specific memory zone of the current record and/or of the following record of the execution data structure.

4. The method for controlling the execution of an application according to claim 3, wherein the method further comprises obtaining in the current record at least one precondition for execution of said current function and wherein the attempting to execute the current function is only triggered if said at least one precondition is satisfied.

5. The method for controlling the execution of an application according to claim 1, wherein the implementing the function having the decoded function name corresponding to the encoded function name comprises introspection of said application, delivering a positive introspection result when a function having the decoded function name is identified among a set of the functions of said application.

6. The method for controlling the execution of an application according to claim 2, wherein the obtaining the decoded function name from the encoded function name of said current record comprises searching for presence of an existing function on the basis of an annotation comprising the encoded function name, said annotation being associated with the function having the decoded function name.

7. The method according to claim 1 wherein the receiving the execution data structure is preceded by establishment of a secure communication link.

8. The method according to claim 1, wherein said execution data structure is encrypted, and the method comprises decrypting the execution data structure.

9. An execution device comprising:
at least one processor;
at least one non-transitory computer-readable medium comprising instructions stored thereon which when executed by the at least one processor configure the execution device to carry out a control of execution of an application, said control being implemented in the application, said application being executed on the at least one processor of said execution device, when said execution device is connected to a caller device via a communication network, wherein the controlling comprises:
receiving from the caller device an execution data structure, comprising at least one record, each record comprising at least one data field comprising an encoded function name;
saving, in a specific memory zone of the at least one non-transitory computer-readable medium, said execution data structure;
for each current record of the execution data structure:
implementing a function having a decoded function name corresponding to the encoded function name, when the function of the application, having a decoded function name can be associated with the encoded function name; and
transmitting to said caller device of a result of execution of the function having a decoded function name so as to control an execution flow by said caller device.

10. At least one non-transitory computer-readable medium comprising program code instructions stored thereon which when executed by at least one processor of an execution device configure the execution device to carry out a control of execution of an application, said control being implemented in the application, said application being executed on the at least one processor of said execution device, when said execution device is connected to a caller device via a communication network, wherein the controlling comprises:
receiving from the caller device an execution data structure, comprising at least one record, each record comprising at least one data field comprising an encoded function name;
saving, in a specific memory zone of the at least one non-transitory computer-readable medium, said execution data structure;
for each current record of the execution data structure:
implementing a function having a decoded function name corresponding to the encoded function name, when the function, of the application, having a decoded function name can be associated with the encoded function name; and
transmitting to said caller device of a result of execution of the function having a decoded function name so as to control an execution flow by said caller device.
